(19) United States
(12) Patent Application Publication
(10) Pub. No.: US 2007/0206210 A1
(43) Pub. Date: Sep. 6, 2007

(54) Image forming apparatus, information processing apparatus, printing system, and image forming method

(76) Inventors: Satoshi Miyazaki, Kanagawa (JP); Masayuki Motohashi, Tokyo (JP)

Correspondence Address: HARNESS, DICKEY & PIERCE, P.L.C., P.O. BOX 8910, RESTON, VA, 20195, US

(21) Appl. No.: 11/521,537

(22) Filed: Sep. 15, 2006

(30) Foreign Application Priority Data
Sep. 21, 2005 (JP) 2005-274420

(51) Int. Cl. G06K 15/00

(52) U.S. Cl. 358/1.14

(57) ABSTRACT

A disclosed image forming apparatus includes an interface unit configured to send/receive data via a communication network to/from an information processing apparatus; a storage unit configured to store a set of print data sent via the communication network from the information processing apparatus; and a data processing unit configured to start a print job for printing the set of print data and to cancel the started print job when the printing of the set of print data is suspended because of a printing error.

### BACKGROUND OF THE INVENTION

1. Field of the Invention

The present invention generally relates to an image forming apparatus, an information processing apparatus, a printing system, and an image forming method, and more particularly relates to an image forming apparatus, an information processing apparatus, a printing system, and an image forming method that provide efficient image forming processing.

2. Description of the Related Art

When print data are sent from an information processing apparatus such as a personal computer (PC) or a server to an image forming apparatus such as a printer, the image forming apparatus prints the print data on a printing medium such as paper based on the print data. If a printing error occurs in the image forming apparatus, the printing is suspended. Printing systems that can continue printing even when a printing error occurs in an image forming apparatus have been proposed (see, for example, patent document 1 and 2). In such printing systems, multiple printers are connected via a network, and if a printing error occurs in a printer while a print job is being executed, the print job is automatically continued on another printer.

A printing system disclosed in patent document 1 includes a computer as an information processing apparatus, multiple printers for printing information output from the computer, and a printer control apparatus configured to switch print destinations based on availability of the printers.

A printing system disclosed in patent document 2 includes a host computer and multiple printers connected via a network. In the printing system, when printing a document is suspended because of an error on a destination printer, remaining pages of the document can be printed on another printer. Also, in a printing system disclosed in patent document 2, if a print job includes multiple printing units (for example, multiple copies) and the printing is suspended in the middle of a printing unit, the printing can be restarted on another printer from the beginning of the printing unit instead of from the middle of the printing unit. This prevents parts of a printing unit from being printed on different printers, thereby improving the convenience for users.

[Patent document 1] Japanese Patent Application Publication No. 10-91370

[Patent document 2] Japanese Patent Application Publication No. 2003-330672

In a printing system as described above, when printing on a first image forming apparatus is suspended because of a printing error in the first image forming apparatus, the printing of remaining pages is continued on a second image forming apparatus. One disadvantage of such a conventional printing system is that, when the printing error is fixed, the printing is restarted on the first image forming apparatus and, as a result, the remaining pages are printed twice.

Also, even if the print job in progress is canceled, subsequent print jobs sent to the first image forming apparatus are not canceled and therefore printed on the first image forming apparatus again after its problem is fixed. In other words, the subsequent print jobs are printed twice.

### SUMMARY OF THE INVENTION

The present invention provides an image forming apparatus, an information processing apparatus, a printing system, and an image forming method that substantially obviate one or more problems caused by the limitations and disadvantages of the related art.

Embodiments of the present invention provide an image forming apparatus, an information processing apparatus, a printing system, and an image forming method that prevent a document from being printed twice and thereby provide efficient image forming processing.

According to an embodiment of the present invention, an image forming apparatus includes an interface unit configured to send/receive data via a communication network to/from an information processing apparatus; a storage unit configured to store a set of print data sent via the communication network from the information processing apparatus; and a data processing unit configured to start a print job for printing the set of print data and to cancel the started print job when the printing of the set of print data is suspended because of a printing error.

In other words, when printing on a first image forming apparatus is suspended because of a printing error in the first image forming apparatus and the printing of remaining pages is continued on a second image forming apparatus, the corresponding print job on the first image forming apparatus is canceled. Therefore, even when the printing error is fixed, the printing is not restarted on the first image forming apparatus. Such a mechanism prevents the remaining pages from being printed twice, thereby providing efficient image forming processing.

According to an embodiment of the present invention, an information processing apparatus includes a print data generating unit configured to generate print data; an interface unit configured to send the print data via a communication network to an image forming apparatus and to receive status information via the communication network from the image forming apparatus; and a data processing unit configured to generate, when the status information contains information indicating that a print job corresponding to the print data has been canceled, another set of print data based on a number of pages that have been successfully printed before the cancellation of the print job which number of pages is contained in the status information, and to cause the interface unit to send said another set of print data to another image forming apparatus to continue the print job on said another image forming apparatus.

The above embodiment prevents the same print data from being printed on multiple image forming apparatuses, thereby making it possible to provide efficient image forming processing.

According to an embodiment of the present invention, a printing system includes two or more image forming apparatuses as described above; and one or more information processing apparatuses as described above.

According to the above embodiment, when printing on a first image forming apparatus is suspended because of a printing error in the first image forming apparatus and the printing of remaining pages is continued on a second image forming apparatus, the corresponding print job on the first image forming apparatus is canceled. Therefore, even when the printing error is fixed, the printing is not restarted on the first image forming apparatus. This mechanism prevents the remaining pages from being printed twice, thereby making it possible to provide efficient image forming processing.

According to an embodiment of the present invention, an image forming method includes a receiving step of receiving a set of print data sent via a communication network from an information processing apparatus; a storing step of storing the set of print data; and a data processing step of starting a print job for printing the set of print data and canceling the started print job when the printing of the set of print data is suspended because of a printing error.

In other words, when printing on a first image forming apparatus is suspended because of a printing error in the first image forming apparatus and the printing of remaining pages is continued on a second image forming apparatus, the corresponding print job on the first image forming apparatus is canceled. Therefore, even when the printing error is fixed, the printing is not restarted on the first image forming apparatus. Such a mechanism provides efficient image forming processing.

As described above, embodiments of the present invention makes it possible to provide efficient image forming processing.

### BRIEF DESCRIPTION OF THE DRAWINGS

FIG. 1 is a drawing illustrating an exemplary configuration of a printing system;

FIG. 2 is a block diagram illustrating an exemplary hardware configuration of an information processing apparatus;

FIG. 3 is a block diagram illustrating an exemplary functional configuration of an information processing apparatus;

FIG. 4 is a block diagram illustrating an exemplary hardware configuration of an image forming apparatus;

FIG. 5 is a block diagram illustrating an exemplary functional configuration of an image forming apparatus;

FIGS. 6A and 6B are flowcharts illustrating exemplary processes in an information processing apparatus according to a first embodiment of the present invention;

FIG. 7 is a flowchart illustrating an exemplary process in an image forming apparatus according to a first embodiment of the present invention;

FIG. 8 is an exemplary job cancellation setting table where a job cancellation setting is provided for each information processing apparatus;

FIG. 9 is a flowchart illustrating an exemplary process in an image forming apparatus according to a third embodiment of the present invention;

FIG. 10 is an exemplary job cancellation setting table where multiple job cancellation settings each corresponding to a printing error type are provided for each information processing apparatus; and

FIG. 11 is an exemplary printing error type setting table showing the correspondence between actual printing error types and specified printing error types to be sent to information processing apparatuses.

### DESCRIPTION OF THE PREFERRED EMBODIMENTS

Preferred embodiments of the present invention are described below with reference to the accompanying drawings.

[Printing System]

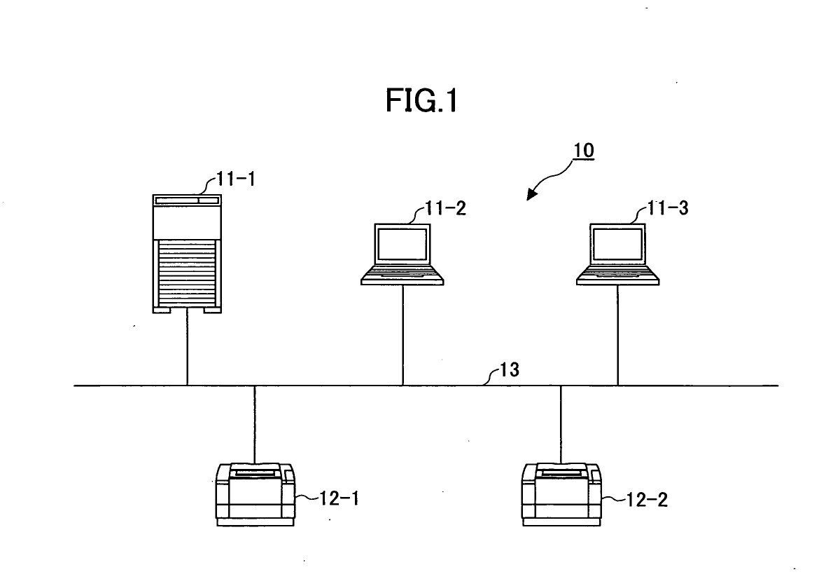

FIG. 1 is a drawing illustrating an exemplary configuration of a printing system. As shown in FIG. 1, a printing system 10 includes information processing apparatuses 11 (11-1 through 11-3), such as PCs or servers, and image forming apparatuses 12 (12-1 and 12-2). The information processing apparatuses 11 and the image forming apparatuses 12 are connected to each other via a communication network 13, such as a local area network (LAN), so as to enable data exchange between them.

The information processing apparatus 11 generates print data to be printed on the image forming apparatus 12 and sends the generated print data via the communication network 13 to the image forming apparatus 12. Also, the information processing apparatus 11 receives status information from the image forming apparatus 12 to which the print data have been sent. The status information reports either the successful completion of a print job or the cancellation of a print job. When the information processing apparatus 11 receives status information reporting the cancellation of a print job, the information processing apparatus 11 sends print data to another image forming apparatus 11 to continue the print job. According to embodiments of the present invention, when printing is suspended on a first image forming apparatus and continued on a second image forming apparatus, the printing is not restarted on the first image forming apparatus. This mechanism is described later in detail.

The image forming apparatus 12 receives print data via the communication network 13 from the information processing apparatus 11 and starts a print job to print the received print data on a printing medium such as paper. When the print job is completed successfully or the print job is suspended because of a printing error, the image forming apparatus 12 generates status information and sends the status information via the communication network 13 to the information processing apparatus 11 from which the print data have been sent. Printing errors include “paper jam”, “out of supply (ink, toner, etc.)”, “out of paper”, and “cover open”.

The number of the information processing apparatuses 11 and the number of the image forming apparatuses 12 in the printing system 10 are not limited to those shown in FIG. 1. The printing system 10, however, includes at least one information processing apparatus 11 and two or more image forming apparatuses 12.

Exemplary configurations of the information processing apparatus 11 and the image forming apparatus 12 are described below. In the descriptions below, it is assumed that the image forming apparatus 12 is a printer. However, the image forming apparatus 12 is not limited to a printer and may be, for example, a multifunction copier including functions of a facsimile, a copier, and a scanner.

[Information Processing Apparatus 11: Hardware Configuration]

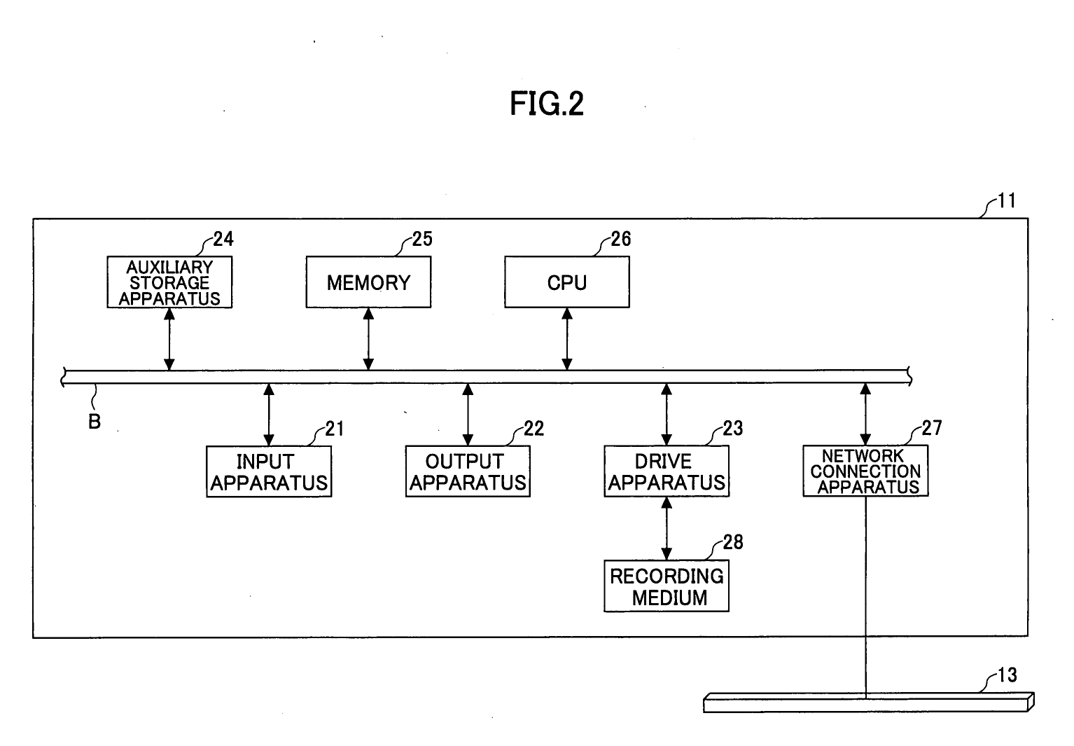

FIG. 2 is a block diagram illustrating an exemplary hardware configuration of an information processing apparatus. As shown in FIG. 2, the information processing apparatus 11 includes an input apparatus 21, an output apparatus 22, a drive apparatus 23, a secondary storage apparatus 24, a memory 25, a central processing unit (CPU) 26 for controlling various processes, and a network connection apparatus 27, which are connected to each other via a bus B so as to enable data exchange between them.

The input apparatus 21 includes a keyboard and a pointing device, such as a mouse, for user operations and inputs operation signals, such as an instruction to execute a program, from the user. The output apparatus 22 includes a display for displaying various data and windows which windows are used to operate the information processing apparatus 11 to perform information processing according to embodiments of the present invention. The CPU 26 displays progress status and processing results on the display of the output apparatus 22 according to a control program.

According to an embodiment of the present invention, programs to be installed into the information processing apparatus 11 are provided, for example, on a recording medium 28 such as a CD-ROM. The recording medium 28 having the programs is mountable on the drive apparatus 23. The programs stored on the recording medium 28 are installed via the drive apparatus 23 into the secondary storage apparatus 24.

The drive apparatus 23 can also record programs according to embodiments of the present invention on the recording medium 28. The recording medium 28 makes it possible to install the recorded programs in other information processing apparatuses, and thereby makes it easier to implement information processing for a printing system.

The secondary storage apparatus 24 is a storage unit such as a hard disk and stores programs according to embodiments of the present invention and control programs of the information processing apparatus 11. The stored programs and control programs can be retrieved from the secondary storage apparatus 24 when necessary. The memory 25 is implemented, for example, with a read only memory (ROM) and a random access memory (RAM) and stores various data used in information processing according to embodiments of the present invention.

The CPU 26 controls processing in the information processing apparatus 11, which processing includes various operations and input/output of data into/from other hardware components, according to programs that are retrieved from the secondary storage apparatus 24 and temporarily stored in the memory 25, and thereby implements information processing for a printing system. The CPU 26 retrieves data necessary for the execution of the programs from the secondary storage apparatus 24 and stores data generated during the execution of the programs in the secondary storage apparatus 24.

The network connection apparatus 27 connects the information processing apparatus 11 via a LAN cable or the like to the communication network 13, thereby making it possible to obtain programs from other terminals (information processing apparatuses) connected to the communication network 13 and to provide other terminals with the results obtained by executing the programs according to embodiments of the present invention or the programs themselves.

As described above, an information processing apparatus for information processing for a printing system according to embodiments of the present invention does not require special equipment and therefore can be implemented at a low cost.

[Information Processing Apparatus 11: Functional Configuration]

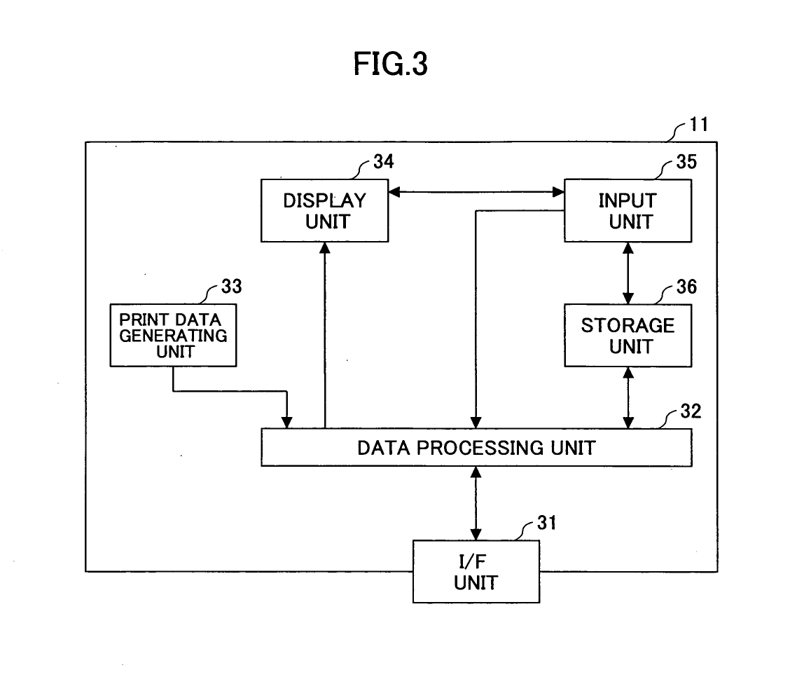

FIG. 3 is a block diagram illustrating an exemplary functional configuration of an information processing apparatus. As shown in FIG. 3, the information processing apparatus 11 includes an interface (I/F) unit 31, a data processing unit 32, a print data generating unit 33, a display unit 34, an input unit 35, and a storage unit 36.

The I/F unit 31 enables data communication with the image forming apparatuses 12 which are connected via the communication network 13 as described above.

The data processing unit 32 generates various data to be sent to the image forming apparatus 12 and performs various processes based on status information received from the image forming apparatus 12. More specifically, the data processing unit 32 selects, via a driver, one of the image forming apparatuses 12 as the destination of print data generated by the print data generating unit 33; and causes the I/F unit 31 to send the print data to the selected image forming apparatus 12. The driver converts the print data generated by the information processing apparatus 11 into a format that can be understood by the image forming apparatus 12.

Also, the data processing unit 32 interprets status information received from the image forming apparatus 12. Status information from the image forming apparatus 12 includes information on a print job that has been canceled, a printing error type, and the number of pages that have been successfully printed before the cancellation of the print job. When receiving status information reporting the cancellation of a print job, the data processing unit 32 generates print data to print remaining pages in the print job and causes the I/F unit 31 to send the print data to a predetermined image forming apparatus 12 to continue the printing. Further, the data processing unit 32 generates a control command to be attached to the print data and displays a printing status message on the display unit 34 based on the status information.

The print data generating unit 33 generates print data to be printed on the image forming apparatus 12. Print data include, in addition to data such as text data or image data that are actually printed, control commands described later, style information such as fonts and character sizes, a paper size, the number of pages, and page information such as a header and a footer. Print data also include address information, such as an Internet Protocol (IP) address, which is used when the data processing unit 32 sends the print data from the information processing apparatus 11 to the image forming apparatus 12.

The display unit 34 displays a printing status message generated based on the status information by the data processing unit 32. The input unit 35 inputs various data from, for example, the user. Data input by the input unit 35 include printing conditions, control commands described later, and print setting information including the address of a second image forming apparatus 12 on which a print job is continued when the print job is canceled on a first image forming apparatus 12.

The storage unit 36 stores, for example, data input by the input unit 35 and data generated by the data processing unit 32. More specifically, the storage unit 36 stores, for example, print setting information defining the actions to be taken when status information reporting the cancellation of a print job is received from the image forming apparatus 12.

The print setting information allows the user to set a specific action to be taken when a print job is canceled, according to the type of the print job. This mechanism is described later in more detail.

[Image Forming Apparatus 12: Hardware Configuration]

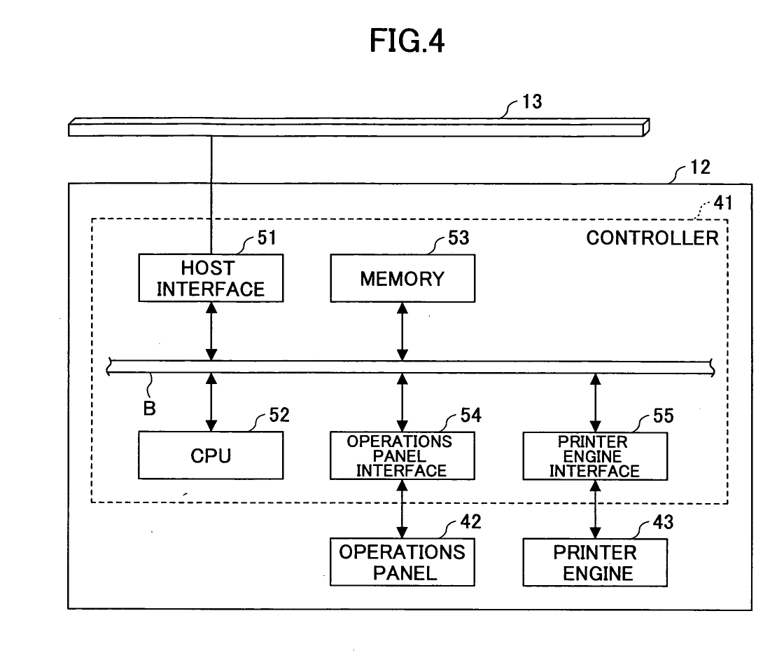

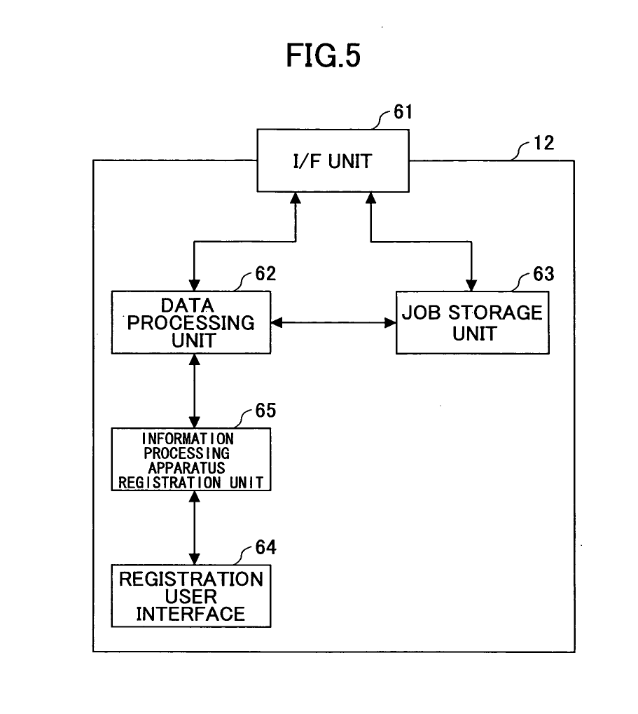

Exemplary hardware and functional configurations of the image forming apparatus 12 are described below with reference to FIGS. 4 and 5. FIG. 4 is a block diagram illustrating an exemplary hardware configuration of an image forming apparatus. As shown in FIG. 4, the image forming apparatus 12 includes a controller 41, an operations panel 42, and a printer engine 43. The controller 41 includes a host interface 51, a CPU 52, a memory 53, an operations panel interface 54, and a printer engine interface 55, which are connected to each other via a bus B so as to enable data exchange between them.

In the image forming apparatus 12 shown in FIG. 4, the controller 41 controls the operations panel 42 and the printer engine 43. Also, the controller 41 controls data exchange with the information processing apparatus 11.

The operations panel 42 is implemented, for example, with a touch panel, and displays various information items. Using the operations panel 42 and based on the displayed information items, the user makes various settings, such as job cancellation settings for the information processing apparatuses 11.

The printer engine 43 performs printing. Also, the printer engine 43 detects a printing error such as “paper jam” or “out of supply”, and outputs the printing error type and the number of pages that have been successfully printed to the data processing unit 32, which is implemented, for example, as a printer application program executed by the CPU 52. “Out of supply” indicates that a supply (toner, photoconductor unit, transfer unit, fixing unit, etc.) needs to be replaced. When “out of supply” occurs, the printer engine 43 displays a message prompting replacement of the corresponding supply on the operations panel 42 and the display unit 34 of the information processing apparatus 11, and suspends printing.

An exemplary process in the controller 41 is described below in detail. The host interface 51 receives print data via the communication network 13 from the information processing apparatus 11. Also, the host interface 51 sends status information, which is generated when a print job is completed or canceled, to the information processing apparatus 11 from which the print data are received.

The CPU 52 controls processing in the image forming apparatus 12, which processing includes various operations and input/output of data into/from other hardware components, according to programs that are stored in the memory 53, and thereby implements data processing for image forming processing. The CPU 52 performs image forming processing according to embodiments of the present invention by using the programs stored in the memory 53.

The memory 53 temporarily stores data during data processing for image forming processing. The memory 53 is implemented, for example, with a ROM and a RAM. The operations panel interface 54 sends/receives information to/from the operations panel 42. More specifically, the operations panel interface 54 receives, from the operations panel 42, settings such as job cancellation settings for the information processing apparatuses 11 which job cancellation settings define whether to cancel a print job when printing is suspended because of a printing error. The operations panel interface 54, under the control of the CPU 52, stores the settings in the memory 53.

The printer engine interface 55 sends print data to the printer engine 53, receives information including a printing error type from the printer engine 53, and performs processing based on the received information.

[Image Forming Apparatus 12: Functional Configuration]

An exemplary functional configuration of the image forming apparatus 12 is described below with reference to FIG. 5. FIG. 5 is a block diagram illustrating an exemplary functional configuration of an image forming apparatus. As shown in FIG. 5, the image forming apparatus 12 includes an interface (I/F) unit 61, a data processing unit 62, a job storage unit 63, a registration user interface 64, and an information processing apparatus registration unit 65.

The I/F unit 61 corresponds to the host interface 51 described above. More specifically, the I/F unit 61 receives print data from the information processing apparatus 11. Also, the I/F unit 61 sends status information, which is generated by the data processing unit 62, to the information processing apparatus 11 from which the print data have been sent.

The data processing unit 62 performs processing based on the print data received from the information processing apparatus 11. More specifically, the data processing unit 62 makes the printer engine 43 perform printing based on the print data. When suspension of printing is reported from the printer engine 43, the data processing unit 62 cancels the print job according to a control command in the print data or according to job cancellation settings registered in the information processing apparatus registration unit 65 of the image forming apparatus 12. The data processing unit 62 generates status information and sends the status information via the I/F unit 61 to the information processing apparatus 11 from which the print data have been sent.

Status information generated by the data processing unit 62 includes information on a print job that has been canceled, a printing error type, and the number of pages that have been successfully printed before the cancellation of the print job. Status information also includes address information, such as an IP address, which is used to send the status information to the information processing apparatus 11. The address information can be obtained from the address information attached to print data.

The job storage unit 63 temporarily stores print data sent from the information processing apparatus 11. The registration user interface 64 corresponds to the operations panel interface 54 described above. More specifically, the registration user interface 64 receives, from the operations panel 42, settings such as job cancellation settings for the information processing apparatuses 11 which job cancellation settings define whether to cancel a print job when printing is suspended because of a printing error; and printing error type settings for the information processing apparatuses 11 which printing error type settings define the correspondence between actual printing error types and user-specified printing error types to be sent to the information processing apparatuses 11. The registration user interface 64 stores the received settings in the information processing apparatus registration unit 65.

Image forming processing using the information processing apparatus 11 and the image forming apparatus 12 according to embodiments of the present invention is described below.

### 1. First Embodiment

In a conventional printing system, if printing on a first image forming apparatus is suspended because of a printing error such as “paper jam”, “out of supply (ink, toner, etc.)”, “out of paper”, or “cover open”, the printing is continued on a second image forming apparatus. One disadvantage of such a conventional printing system is that, when the printing error is fixed, the printing is restarted on the first image forming apparatus and, as a result, pages that have been printed on the second image forming apparatus are printed again on the first image forming apparatus.

According to embodiments of the present invention, when printing is suspended, the corresponding print job is canceled. A first embodiment of the present invention is described below in detail. Take, for example, a situation where the print processing system 10 shown in FIG. 1 includes the information processing apparatus 11-1 and the image forming apparatuses 12-1 and 12-2, which are connected to each other via the communication network 13. In the print processing system 10, the information processing apparatus 11-1 sends print data to the image forming apparatus 12-1. The image forming apparatus 12-1 receives the print data sent from the information processing apparatus 11-1 and starts a print job to print the received print data on a printing medium.

If the printing is suspended in the middle because of a printing error, the image forming apparatus 12-1 cancels the print job. Then, the image forming apparatus 12-1 generates status information reporting the cancellation of the print job and sends the generated status information to the information processing apparatus 11-1 from which the print data have been sent. Status information includes information on a print job (print data) that has been canceled, a printing error type, and the number of pages that have been successfully printed before the cancellation of the print job.

The information processing apparatus 11-1 receives the status information sent from the image forming apparatus 12-1, and generates print data to print the remaining pages based on the number of pages that have been printed contained in the status information. The information processing apparatus 11-1 sends the generated print data to the image forming apparatus 12-2. The image forming apparatus 12-2 receives the print data and prints the remaining pages. The image forming apparatus 12-1 cancels a print job in progress when a printing error occurs, even if the print job is in the middle of printing a page. The page the printing of which has been stopped in the middle is not included in the number of pages that have been successfully printed.

In the above process, the information processing apparatus 11-1 displays on its display unit a message to report that the printing has been continued on the image forming apparatus 12-2. For example, a message such as “Because of a printing error in the image forming apparatus 12-1, printing of page xx and subsequent pages has been continued on the image forming apparatus 12-2” is displayed on the display unit of the information processing apparatus 11-1. Such a message allows the user to know the status or the result of a print job.

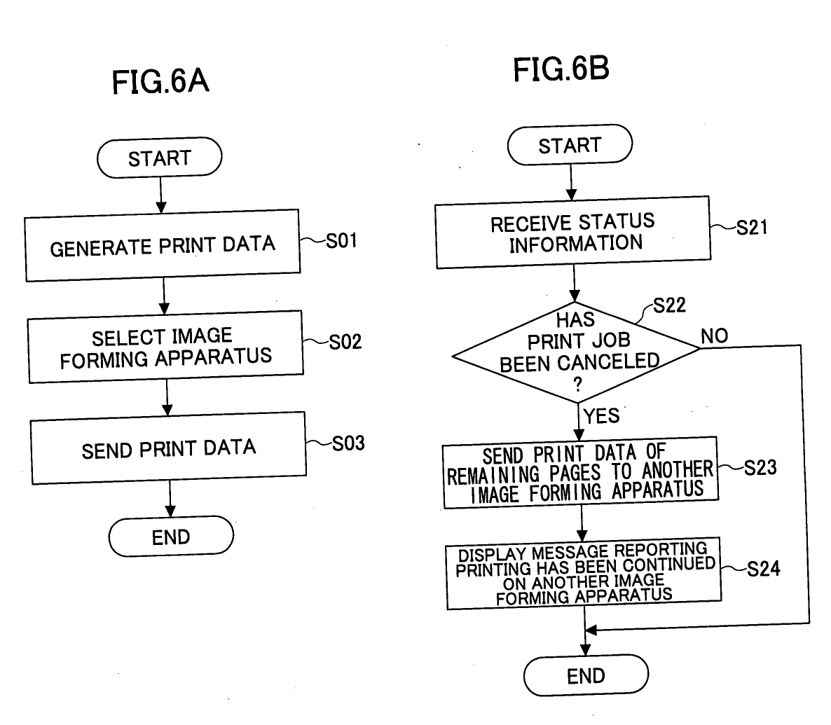

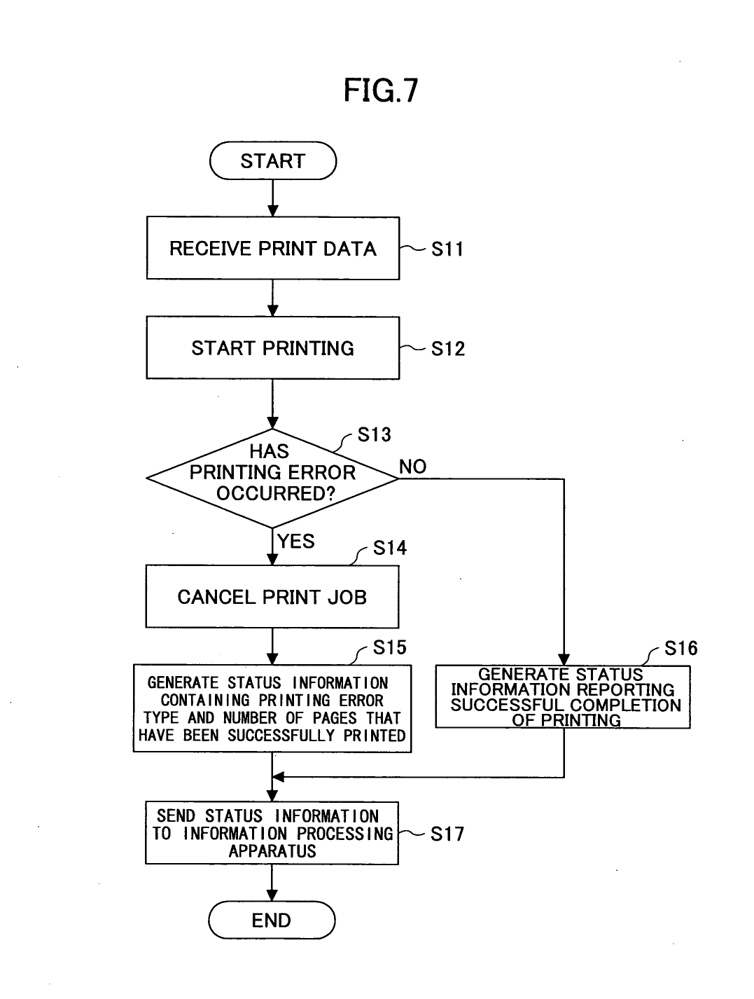

The above processes are described below in detail with reference to flowcharts. FIGS. 6A and 6B are flowcharts illustrating exemplary processes in the information processing apparatus 11 according to the first embodiment of the present invention. FIG. 7 is a flowchart illustrating an exemplary process in the image forming apparatus 12 according to the first embodiment of the present invention. FIG. 6A shows an exemplary process where the information processing apparatus 11-1 sends print data to the image forming apparatus 12-1, and FIG. 6B shows an exemplary process where the information processing apparatus 11-1, in response to status information from the image forming apparatus 12-1, continues printing on the image forming apparatus 12-2.

In FIG. 6A, the information processing apparatus 11 generates print data (SO1), and selects one of the image forming apparatuses 12 (in this example, the image forming apparatus 12-1) to print the print data on a printing medium (S02). When one of the image forming apparatuses 12 is already selected, step S02 is omitted. Then, the information processing apparatus 11-1 sends the print data to the selected image forming apparatus 12-1 (S03).

As shown in FIG. 7, the print data sent from the information processing apparatus 11-1 are received by the image forming apparatus 12-1 (S11). The image forming apparatus 12-1 analyzes the received print data and starts printing the print data (S12). The image forming apparatus 12-1 determines whether a printing error has occurred before the printing is suspended (S13). If a printing error has occurred (YES in step S13), the image forming apparatus 12-1 cancels the print job in progress (S14). Then, the image forming apparatus 12-1 generates status information including the type of the printing error and the number of pages that have been successfully printed before the cancellation of the print job (S15).

If no printing error has occurred and the printing of the print data has been completed successfully (NO in step S13), the image forming apparatus 12-1 generates status information reporting the successful completion of the printing (S16). The image forming apparatus 12-1 then sends the status information generated in step S15 or S16 to the information processing apparatus 11-1 from which the print data have been sent (S17).

As shown in FIG. 6B, the information processing apparatus 11-1 receives the status information (S21) and determines based on the status information whether the print job has been canceled (S22). If the print job has been canceled (YES in step S22), the information processing apparatus 11-1 obtains the number of pages that have been successfully printed from the status information, generates print data to print pages that have not been printed yet, and sends the print data to a predetermined image forming apparatus (in this example, the image forming apparatus 12-2) (S23). The information processing apparatus 11-1 then displays a message on its display unit to report that the printing has been continued on the image forming apparatus 12-2 (S24). If the print job has not been canceled (NO in step S22), the information processing apparatus 11-1 ends the process.

As describe above, according to the first embodiment of the present invention, when printing on a first image forming apparatus is suspended because of a printing error in the first image forming apparatus and the printing is continued on a second image forming apparatus, the corresponding print job on the first image forming apparatus is canceled. Therefore, even when the printing error is fixed, the printing is not restarted on the first image forming apparatus. This mechanism prevents the remaining pages in the print job from being printed twice and thereby provides efficient image forming processing.

### 2. Second Embodiment

According to the first embodiment, when a printing error occurs in a first image forming apparatus, only the print job in progress on the first image forming apparatus is canceled. In this case, when multiple sets of print data are sent to the first image forming apparatus and stored in the job storage unit 63, the stored sets of print data are printed on the first image forming apparatus after the printing error is fixed. In other words, the stored sets of print data are printed both on the first and second image forming apparatuses.

According to a second embodiment, when a printing error occurs in an image forming apparatus, sets of print data (print jobs) stored in the job storage unit 63 and sets of print data sent from an information processing apparatus via the communication network 13 during a period from when the printing error occurs until the printing error is fixed are also canceled. In other words, all print jobs are canceled in step S14 of FIG. 7, and status information for the canceled print jobs is generated in step S15.

In this case, status information may be generated separately for each print job, or multiple sets of status information for the print jobs from the same information processing apparatus may be combined into a single set of status information. Combining multiple sets of status information into a single set of status information may reduce the data traffic. The image forming apparatus sends the generated status information to the information processing apparatus. In the status information of a print job that has not been started yet, “0” is specified as the number of pages that have been successfully printed.

The second embodiment of the present invention is described below in detail. Take, for example, a situation where the print processing system 10 shown in FIG. 1 includes the information processing apparatus 11-1 and the image forming apparatuses 12-1 and 12-2, which are connected to each other via the communication network 13. In the print processing system 10, the information processing apparatus 11-1 sends multiple sets of print data to the image forming apparatus 12-1.

The image forming apparatus 12-1 receives the multiple sets of print data from the information processing apparatus 11-1 and prints the multiple sets of print data set by set. If printing of a set of print data is suspended in the middle because of a printing error, the image forming apparatus 12-1 cancels the corresponding print job and all the sets of print data (print jobs) received from the information processing apparatus 11-1 and stored in the job storage unit 63. Then, the image forming apparatus 12-1 generates status information reporting the cancellation of the print job, and sends the generated status information to the information processing apparatus 11-1. The information processing apparatus 11-1 generates print data to print pages that have not been printed yet and sends the print data to the image forming apparatus 12-2, thereby continuing the printing.

The information processing apparatus 11-1 displays on its display unit a message to report that the printing has been continued on the image forming apparatus 12-2. For example, a message such as “Page xx and subsequent pages of xxx.txt (file name) have been printed on the image forming apparatus 12-2” is displayed on the display unit of the information processing apparatus 11-1.

As described above, according to the second embodiment of the present invention, when printing is suspended because of a printing error in a first image forming apparatus, both the corresponding print job and the stored print jobs on the first image forming apparatus are canceled and the printing of those print jobs is continued on a second image forming apparatus. Therefore, even when the printing error is fixed, the print jobs are not restarted on the first image forming apparatus. This mechanism prevents print data from being printed twice.

### 3. Third Embodiment

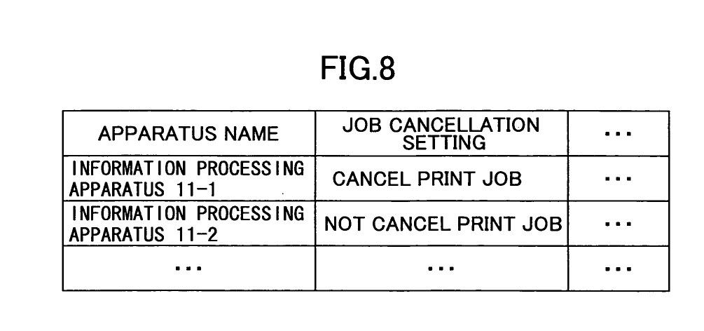

According to a third embodiment of the present invention, when multiple information processing apparatuses are connected to an image forming apparatus, whether to cancel a print job (job cancellation setting) can be specified for each information processing apparatus. Exemplary job cancellation settings are described below with reference to FIG. 8. FIG. 8 is an exemplary job cancellation setting table where a job cancellation setting is provided for each information processing apparatus. The exemplary job cancellation setting table is stored in an image forming apparatus and includes the names (identifiers) of information processing apparatuses and job cancellation settings corresponding to the information processing apparatuses. For example, when printing of print data sent from the information processing apparatus 11-1 is suspended because of a printing error, the corresponding print job is canceled; when printing of print data sent from the information processing apparatus 11-2 is suspended because of a printing error, the corresponding print job is not canceled but is suspended until the printing error is fixed.

In the job cancellation setting table shown in FIG. 8, whether to cancel a print job is determined based solely on the information processing apparatus from which the print job has been sent. However, types of print data (image data, text data, and so on), the number of print jobs in a print queue, data sizes, time when a printing error occurs, and the capacity of an image forming apparatus, for example, may also be used as parameters.

Job cancellation settings are specified by the user using the registration user interface 64; and the specified job cancellation settings are stored in the information processing apparatus registration unit 65. However, the method of specifying job cancellation settings is not limited to the above described method. For example, job cancellation settings may be generated on another apparatus, sent to an image forming apparatus via the communication network 13, and stored in the information processing apparatus registration unit 65 via the I/F unit 61 and the data processing unit 62.

The third embodiment of the present invention is described below in detail. Take, for example, a situation where the print processing system 10 shown in FIG. 1 includes the information processing apparatuses 11-1 and 11-2 and the image forming apparatuses 12-1 and 12-2, which are connected to each other via the communication network 13; and the job cancellation setting table shown in FIG. 8 is registered in the information processing apparatus registration unit 65 of the image forming apparatus 12-1. In the exemplary job cancellation setting table, the job cancellation setting for the information processing apparatus 11-1 is “Cancel print job” and the job cancellation setting for the information processing apparatus 11-2 is “Not cancel print job”.

When printing of print data sent from the information processing apparatus 11-1 is suspended because of a printing error in the image forming apparatus 12-1, the corresponding print job is canceled and the printing is continued on the image forming apparatus 12-2. When printing of print data sent from the information processing apparatus 11-2 is suspended because of a printing error in the image forming apparatus 12-1, the corresponding print job is not canceled but is suspended until the printing error is fixed.

For example, when a paper jam occurs, the print job is suspended until the jammed paper is removed and the image forming apparatus is restored to its normal state. The printer engine 43 detects that the jammed paper is removed and outputs a print restart event to the data processing unit 62. The printer engine 43 can also detect recovery from other printing errors.

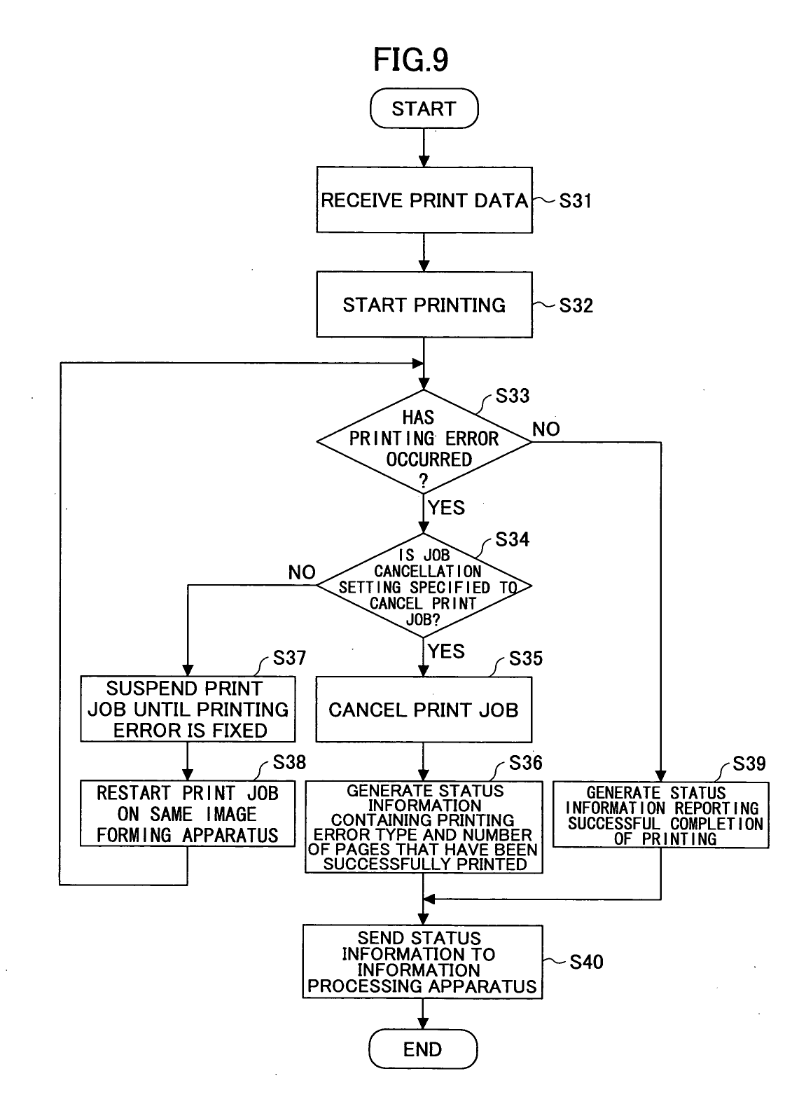

The above processes according to the third embodiment of the present invention are described below in detail with reference to a flowchart. The processes in the information processing apparatus according to the third embodiment of the present invention are substantially the same as in FIGS. 6A and 6B. Therefore, descriptions of the processes in the information processing apparatus are omitted here. FIG. 9 is a flowchart illustrating an exemplary process in an image forming apparatus according to the third embodiment of the present invention.

Print data sent from the information processing apparatus 11 are received by the image forming apparatus 12 (S31). The image forming apparatus 12 analyzes the received print data and starts printing the print data (S32). The image forming apparatus 12 determines whether a printer error has occurred before the printing is stopped (S33). If a printer error has occurred (YES in step S33), the image forming apparatus 12 determines whether to cancel the corresponding print job based on the job cancellation setting for the information processing apparatus 12 (S34).

If the job cancellation setting is “Cancel print job” (YES in step S34), the image forming apparatus 12 cancels the corresponding print job (S35). Then, the image forming apparatus 12 generates status information including the type of the printing error and the number of pages that have been successfully printed before the cancellation of the print job (S36).

If the job cancellation setting is “Not cancel print job” (NO in step S34), the image forming apparatus 12 does not cancel but suspends the print job until the printing error is fixed (S37). When the printing error is fixed, the image forming apparatus 12 restarts the print job (S38) and returns to step S33.

If no printing error has occurred and the printing of the print data has been completed successfully (NO in step S33), the image forming apparatus 12 generates status information reporting the successful completion of the printing (S39). The image forming apparatus 12 then sends the status information generated in step S36 or S39 to the information processing apparatus 11 from which the print data have been sent (S40).

According to the third embodiment, in an environment where multiple information processing apparatuses are connected to an image forming apparatus, a job cancellation setting can be specified for each information processing apparatus to suit its use. Such a mechanism improves the productivity of a printing system.

### 4. Fourth Embodiment

A mission-critical system for handling routine work such as sales management, inventory control, and accounting of a company is normally used without change for a long period of time after installation, and therefore it is difficult to make changes to an information processing apparatus in the system. However, an information processing apparatus in such a mission-critical system may not necessarily be able to respond to all printing errors.

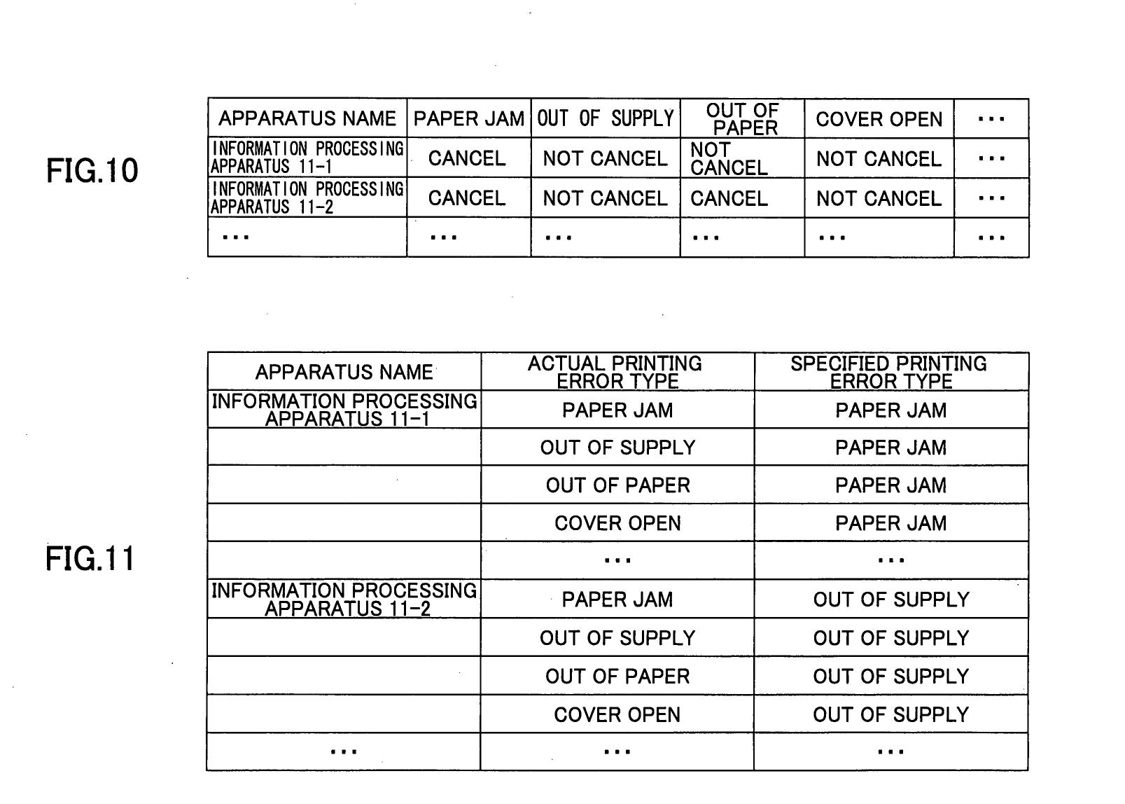

According to a fourth embodiment of the present invention, multiple job cancellation settings each corresponding to a printing error type can be specified for each information processing apparatus. The fourth embodiment of the present invention is described below with reference to FIG. 10. FIG. 10 is an exemplary job cancellation setting table where multiple job cancellation settings each corresponding to a printing error type are provided for each information processing apparatus.

For example, when “paper jam” occurs while a print job for the information processing apparatus 11-1 is being executed, the print job is canceled. When “out of supply”, “out of paper”, or “cover open” occurs while a print job of the information processing apparatus 11-1 is being executed, the print job is not canceled but suspended until the printing error is fixed. The suspended print job is restarted when the printing error is fixed. Parameters in the job cancellation setting table may not be limited to information processing apparatuses and printing errors. Other parameters such as types of print data, data sizes, time when a printing error occurs, and the capacity of an image forming apparatus may also be used.

The fourth embodiment of the present invention is described below in detail. Take, for example, a situation where the print processing system 10 shown in FIG. 1 includes the information processing apparatus 11-1 and the image forming apparatuses 12-1 and 12-2, which are connected to each other via the communication network 13; and the exemplary job cancellation setting table shown in FIG. 10 is registered in the information processing apparatus registration unit 65 of the image forming apparatus 12-1.

According to the exemplary job cancellation setting table shown in FIG. 10, when printing of print data sent from the information processing apparatus 11-1 is suspended because of “paper jam” in the image forming apparatus 12-1, the corresponding print job is canceled in step S35 shown in FIG. 9. When the printing error is “out of supply”, the print job is not canceled but suspended until the printing error is fixed.

The fourth embodiment of the present invention enables specifying multiple job cancellation settings each corresponding to a printing error type for each information processing apparatus, thereby making it possible to send status information to an information processing apparatus only when a printing error to which the information processing apparatus can respond occurs. The fourth embodiment, therefore, makes it possible to provide efficient image forming processing even in a system, for example, a mission-critical system, where it is difficult to make changes to an existing information processing apparatus.

### 5. Fifth Embodiment

In the third and fourth embodiments described above, job cancellation settings for information processing apparatuses must be registered beforehand in a destination image forming apparatus. A fifth embodiment makes it possible to provide image forming processing according to the present invention for an information processing apparatus that has no job cancellation setting in a destination image forming apparatus. More specifically, according to the fifth embodiment, a job cancellation setting can be specified by using a control command from an information processing apparatus. The control command is attached to print data and sent to an image forming apparatus.

The fifth embodiment of the present invention is described below in detail. Take, for example, a situation where the print processing system 10 shown in FIG. 1 includes the information processing apparatus 11-1 and the image forming apparatuses 12-1 and 12-2, which are connected to each other via the communication network 13. For example, the information processing apparatus 11-1 generates a control command telling the image forming apparatus 12-1 to cancel a print job when “paper jam” or “out of supply” occurs and not to cancel a print job when “out of paper” or “cover open” occurs. The information processing apparatus 11-1 attaches the control command to print data and sends the print data to the image forming apparatus 12-1.

When “paper jam” or “out of supply” occurs while printing the print data sent from the information processing apparatus 11-1, the image forming apparatus 12-1, according to the control command, cancels the corresponding print job in step S35 shown in FIG. 9 and sends status information to the information processing apparatus 11-1. The information processing apparatus 11-1 receives the status information and continues the printing on the image forming apparatus 12-2. When “out of paper” or “cover open” occurs, the image forming apparatus 12-1, according to the control command, does not cancel but suspends the print job until the printing error is fixed.

In an environment where multiple information processing apparatuses are connected to an image forming apparatus, the fifth embodiment makes it possible to specify a job cancellation setting by using a control command from an information processing apparatus, thereby eliminating the need to register job cancellation settings beforehand in a destination image forming apparatus. Such a mechanism improves the productivity of a printing system.

### 6. Sixth Embodiment

When job cancellation settings are specified using a control command as described in the fifth embodiment, the order of priority of registered job cancellation settings and job cancellation settings specified by the control command must be determined. For example, when job cancellation settings specified by the control command are given priority, the data processing unit 62 of the image forming apparatus 12 executes a print job according to the job cancellation settings specified by the control command. If no control command is attached to print data, the data processing unit 62 executes a print job according to job cancellation settings registered in the information processing apparatus registration unit 65.

A sixth embodiment of the present invention is described below in detail. Take, for example, a situation where the print processing system 10 shown in FIG. 1 includes the information processing apparatus 11-1 and the image forming apparatuses 12-1 and 12-2, which are connected to each other via the communication network 13. For example, the job cancellation settings registered in the information processing apparatus registration unit 65 of the image forming apparatus 12-1 are specified so that when “paper jam” occurs, the corresponding print job is canceled; and when any one of the other printing errors occurs, the corresponding print job is not canceled.

On the other hand, for example, the information processing apparatus 11-1 generates a control command telling the image forming apparatus 12-1 to cancel the corresponding print job when “paper jam” or “out of supply” occurs and not to cancel the corresponding print job when “out of paper” or “cover open” occurs; attaches the control command to print data; and sends the print data to the image forming apparatus 12-1. In such a case, when “out of supply” occurs, the image forming apparatus 12-1 gives priority to the job cancellation settings by the control command and cancels the corresponding print job in step 35 shown in FIG. 9. The information processing apparatus 11-1 receives status information from the image forming apparatus 12-1, and continues the printing on the image forming apparatus 12-2.

As described above, the sixth embodiment makes it possible to give priority to job cancellation settings specified by a control command sent from an information processing apparatus, thereby enabling flexible use of an image forming apparatus according to circumstances without changing job cancellation settings registered in the image forming apparatus. Such a mechanism improves the productivity of a printing system. Also, the sixth embodiment makes it possible to provide image forming processing according to the present invention for an information processing apparatus that has no job cancellation setting in a destination image forming apparatus.

### 7. Seventh Embodiment

In the fourth embodiment described above, to provide efficient image forming processing in a mission-critical system or the like, status information is sent to an information processing apparatus only when a printing error to which the information processing apparatus can respond occurs. However, to achieve more efficient image forming processing, it is preferable to cancel a print job even when printing on an image forming apparatus is suspended because of a printing error to which the information processing apparatus cannot respond, and to continue the printing on another image forming apparatus.

According to a seventh embodiment, when a printing error occurs, the image forming apparatus 12 generates status information containing a fixed printing error type to which the information processing apparatus 11 can respond regardless of the actual printing error type, and sends the status information to the information processing apparatus 11.

For example, when the information processing apparatus 11 in a mission-critical system can respond only to the printing error type “paper jam”, “paper jam” is used as the fixed printing error type. This mechanism enables changing a printing error type to be sent from the image forming apparatus 12 to suit the information processing apparatus 11, thereby making it possible to continue suspended printing on a different image forming apparatus even in a mission-critical system, where it is difficult to make changes to existing information processing apparatuses. In the above example, it is assumed that the information processing apparatus 11 cannot respond to printing error types other than “paper jam”.

The seventh embodiment of the present invention is described below in detail. Take, for example, a situation where the print processing system 10 shown in FIG. 1 includes the information processing apparatus 11-1 and the image forming apparatuses 12-1 and 12-2, which are connected to each other via the communication network 13; and the information processing apparatus 11-1 sends print data to the image forming apparatus 12-2 to continue printing only when the printing error type is “paper jam”.

When printing on the image forming apparatus 12-1 is suspended because of a printing error, the image forming apparatus 12-1 generates status information containing a fixed printing error type “paper jam” regardless of the actual printing error type, and sends the status information to the information processing apparatus 11-1. The information processing apparatus 11-1 receives the status information and continues the printing on the image forming apparatus 12-2. In this way, the seventh embodiment of the present invention makes it possible for the information processing apparatus 11-1 to continue the printing on the image forming apparatus 12-2 without changing or updating the system of the information processing apparatus 11-1.

According to the seventh embodiment, the image forming apparatus 12-1 generates, in step S36 shown in FIG. 9, status information including the number of pages that have been successfully printed before the cancellation of a print job and a fixed printing error type.

As described above, the seventh embodiment makes it possible for an image forming apparatus to generate status information containing a fixed printing error type to which an information processing apparatus can respond regardless of the actual printing error type and to send the status information to the information processing apparatus, thereby making it possible to provide efficient image forming processing even in a system, for example, a mission-critical system having information processing apparatuses that can respond only to a specific printing error type.

### 8. Eighth Embodiment

In the seventh embodiment described above, an actual printing error type is changed into a fixed printing error type. An eighth embodiment according to the present invention makes it possible to specify a printing error type to be included in status information to support a wide range of mission-critical systems.

The eighth embodiment of the present invention is described below in detail. Take, for example, a situation where the print processing system 10 shown in FIG. 1 includes the information processing apparatuses 11-1 and 11-2 and the image forming apparatuses 12-1 and 12-2, which are connected to each other via the communication network 13; and the information processing apparatuses 11-1 and 11-2 can respond only to “paper jam” and “out of supply”. In such a case, “paper jam” or “out of supply” is specified as the printing error type to be included in status information and registered in the image forming apparatus 12-1. For example, when printing of print data from the information processing apparatus 11-1 is suspended because of a printing error, the image forming apparatus 12-1 sets the specified printing error type (“paper jam” or “out of supply”) in status information regardless of the actual printing error type and sends the status information to the information processing apparatus 11-1. In this way, the eighth embodiment of the present invention makes it possible for the information processing apparatus 11-1 to continue the printing on the image forming apparatus 12-2 without changing or updating the system of the information processing apparatus 11-1.

According to the eighth embodiment, as in the seventh embodiment, the image forming apparatus 12-1 generates, in step S36 shown in FIG. 9, status information including the number of pages that have been successfully printed before the cancellation of a print job and a specified printing error type.

As described above, the eighth embodiment makes it possible to specify a printing error type to be included in status information, thereby supporting a wide range of mission-critical systems each of which systems having information processing apparatuses that can respond to a different printing error type.

### 9. Ninth Embodiment

In a case where multiple information processing apparatuses are connected to an image forming apparatus and each of the information processing apparatuses can respond only to a different printing error type, a ninth embodiment according to the present invention makes it possible to specify a printing error type to be included in status information for each of the information processing apparatuses.

The ninth embodiment of the present invention is described below with reference to FIG. 11. FIG. 11 is an exemplary printing error type setting table showing the correspondence between actual printing error types and specified printing error types to be sent to information processing apparatuses. The exemplary printing error type setting table shown in FIG. 11 is stored, for example, in the image forming apparatus 12-1. In the printing error type setting table, the printing error type settings for the information processing apparatus 11-1 are specified so that status information containing the printing error type “paper jam” is sent regardless of the actual printing error type; and the printing error type settings for the information processing apparatus 11-2 are specified so that status information containing the printing error type “out of supply” is sent regardless of the actual printing error type.

The ninth embodiment of the present invention is described below in detail. Take, for example, a situation where the print processing system 10 shown in FIG. 1 includes the information processing apparatuses 11-1 and 11-2 and the image forming apparatuses 12-1 and 12-2, which are connected to each other via the communication network 13; the information processing apparatus 11-1 can respond only to “paper jam”; the information processing apparatus 11-2 can respond only to “out of supply”; and the exemplary printing error type setting table shown in FIG. 11 is stored in the information processing apparatus registration unit 65 of the image forming apparatus 12-1.

In the above case, for example, when print data are sent from the information processing apparatus 11-1 to the image forming apparatus 12-1 and the printing on the image forming apparatus 12-1 is suspended because of “out of supply”, the image forming apparatus 12-1 generates status information containing the printing error type “paper jam” according to the printing error type settings and sends the status information to the information processing apparatus 11-1.

In this way, the ninth embodiment of the present invention makes it possible for the information processing apparatuses 11-1 and 11-2, each of which can respond to a different printing error type, to continue printing on the image forming apparatus 12-2 without changing or updating the systems of the information processing apparatuses 11-1 and 11-2.

According to the ninth embodiment, a printing error type to be included in status information is specified for each information processing apparatus and is stored in a destination image forming apparatus. This mechanism eliminates the need to make changes to an information processing apparatus and thereby makes it possible to efficiently implement a printing system even in a mission-critical system having multiple information processing apparatuses.

[Programs]

The information processing apparatus 11 and the image forming apparatus 12 may also be able to generate programs (an information processing program and an image forming program) for causing a computer to perform information processing and image forming processing according to the above described embodiments of the present invention. For example, the image forming program can be installed in a controller of another image forming apparatus to provide image forming processing as described above.

Also, the information processing program can be installed in another information processing apparatus to provide information processing as described above.

The information processing program and the image forming program may be downloaded by another apparatus via a communication network. The information processing program and the image forming program may also be provided on a computer-readable recording medium. Such a recording medium makes it easier to install the programs in other information processing apparatuses.

As described above, embodiments of the present invention makes it possible to provide efficient image forming processing.

More specifically, according to embodiments of the present invention, when printing on a first image forming apparatus is suspended because of a printing error in the first image forming apparatus and the printing of remaining pages is continued on a second image forming apparatus, the corresponding print job on the first image forming apparatus is canceled. Therefore, even when the printing error is fixed, the printing is not restarted on the first image forming apparatus. This mechanism prevents the remaining pages from being printed twice.

Two or more of first through ninth embodiments described above may be combined to provide efficient image forming processing.

According to an embodiment of the present invention, an image forming apparatus includes an interface unit configured to send/receive data via a communication network to/from an information processing apparatus; a storage unit configured to store a set of print data sent via the communication network from the information processing apparatus; and a data processing unit configured to start a print job for printing the set of print data and to cancel the started print job when the printing of the set of print data is suspended because of a printing error.

According to an embodiment of the present invention, the data processing unit, after canceling the started print job, generates status information containing a printing error type of the printing error and the number of pages that have been successfully printed before the cancellation of the started print job; and causes the interface unit to send the generated status information to the information processing apparatus.

The information on the number of pages that have been successfully printed makes it possible to print only the remaining pages on another image forming apparatus.

According to an embodiment of the present invention, the data processing unit, when canceling the started print job, also cancels all sets of print data stored in the storage unit.

In other words, when printing is suspended because of a printing error in a first image forming apparatus, the corresponding print job and other print jobs stored in the first image forming apparatus are continued on a second image forming apparatus, and both the corresponding print job and the other print jobs in the first image forming apparatus are canceled. Therefore, even when the printing error is fixed, the print jobs are not restarted on the first image forming apparatus. This mechanism prevents print data of the print jobs from being printed twice.

According to an embodiment of the present invention, the image forming apparatus further includes a registration user interface unit configured to input a job cancellation setting for each of multiple information processing apparatuses, wherein the data processing unit determines according to the input job cancellation setting whether to cancel a print job; and an information processing apparatus registration unit configured to register the input job cancellation setting.

In an environment where multiple information processing apparatuses are connected to an image forming apparatus, the above embodiment makes it possible to specify a job cancellation setting for each information processing apparatus to suit its use. Such a mechanism improves the productivity of a printing system.

According to an embodiment of the present invention, multiple job cancellation settings each corresponding to a printing error type are input and registered for each of multiple information processing apparatuses.

The above embodiment of the present invention enables specifying multiple job cancellation settings each corresponding to a printing error type for each information processing apparatus, thereby making it possible to send status information to an information processing apparatus only when a printing error to which the information processing apparatus can respond occurs. The above embodiment, therefore, makes it possible to provide efficient image forming processing even in a system, for example, a mission-critical system, where it is difficult to make changes to an existing information processing apparatus.

According to an embodiment of the present invention, each set of print data contains a control command that specifies job cancellation settings each corresponding to a printing error type.

In an environment where multiple information processing apparatuses are connected to an image forming apparatus, the above embodiment enables specifying job cancellation settings by using a control command from an information processing apparatus, thereby eliminating the need to register job cancellation settings beforehand in a destination image forming apparatus. Such a mechanism improves the productivity of a printing system.

According to an embodiment of the present invention, the data processing unit gives priority to the job cancellation settings specified by the control command over the job cancellation settings registered in the information processing apparatus registration unit.

According to the above embodiment, the job cancellation settings specified by a control command are given priority. Therefore, it is not necessary to change the job cancellation settings registered in the information processing apparatus registration unit. Such a mechanism makes it possible to flexibly use an image forming apparatus according to circumstances, thereby improving the productivity of a printing system.

According to an embodiment of the present invention, the data processing unit generates status information containing a fixed printing error type regardless of an actual printing error type.

The above embodiment makes it possible for an image forming apparatus to generate status information containing a fixed printing error type to which an information processing apparatus can respond regardless of the actual printing error type and to send the status information to the information processing apparatus, thereby making it possible to provide efficient image forming processing even in a system, for example, a mission-critical system having information processing apparatuses that can respond only to a specific printing error type.

According to an embodiment of the present invention, a printing error type to be included in status information can be specified, and the data processing unit generates status information containing the specified printing error type regardless of the actual printing error type.

The above embodiment makes it possible to specify a printing error type to be included in status information, thereby supporting a wide range of mission-critical systems each of which systems having information processing apparatuses that can respond to a different printing error type.

According to an embodiment of the present invention, when the image forming apparatus is connected via the communication network to two or more information processing apparatuses, a printing error type to be included in status information can be specified for each of the information processing apparatuses.

According to the above embodiment, a printing error type to be included in status information can be specified for each of multiple information processing apparatuses. This mechanism eliminates the need to make any changes to an information processing apparatus and thereby makes it possible to efficiently implement a printing system even in a mission-critical system having multiple information processing apparatuses.

According to an embodiment of the present invention, an image forming method includes a receiving step of receiving a set of print data sent via a communication network from an information processing apparatus; a storing step of storing the set of print data; and a data processing step of starting a print job for printing the set of print data and canceling the started print job when the printing of the set of print data is suspended because of a printing error.

According to an embodiment of the present invention, in the data processing step, after the started print job is canceled, status information is generated which status information contains a printing error type of the printing error and the number of pages that have been successfully printed before the cancellation of the started print job; and the generated status information is sent to the information processing apparatus.

The information on the number of pages that have been successfully printed makes it possible to print only the remaining pages on another image forming apparatus.

According to an embodiment of the present invention, in the data processing step, when the started print job is canceled, all sets of print data stored in the storage step are also canceled.

In other words, when printing is suspended because of a printing error in a first image forming apparatus, the corresponding print job and other print jobs stored in the first image forming apparatus are continued on a second image forming apparatus, and both the corresponding print job and the other print jobs in the first image forming apparatus are canceled. Therefore, even when the printing error is fixed, the print jobs are not restarted on the first image forming apparatus. This mechanism prevents print data of the print jobs from being printed twice.

According to an embodiment of the present invention, the image forming method further includes a job cancellation setting step of inputting multiple job cancellation settings for each said information processing apparatus each of which job cancellation settings corresponding to a printing error type; and a job cancellation setting registration step of registering the input job cancellation settings, wherein each set of print data contains a control command that specifies job cancellation settings each corresponding to a printing error type; whether to cancel a print job is determined in the data processing step according to the job cancellation settings; and the job cancellation settings specified by the control command are given priority over the job cancellation settings registered in the job cancellation setting registration step.

According to the above embodiment, the job cancellation settings specified by a control command are given priority. Therefore, it is not necessary to change the job cancellation settings registered in the job cancellation setting registration step. Such a mechanism makes it possible to flexibly use an image forming apparatus according to circumstances, thereby improving the productivity of a printing system.

According to an embodiment of the present invention, in the data processing step, status information containing a fixed printing error type is generated regardless of the actual printing error type.

The above embodiment makes it possible to generate status information containing a fixed printing error type to which an information processing apparatus can respond regardless of the actual printing error type and to send the status information to the information processing apparatus, thereby making it possible to provide efficient image forming processing even in a system, for example, a mission-critical system having information processing apparatuses that can respond only to a specific printing error type.

According to an embodiment of the present invention, a printing error type to be included in status information can be specified; and in the data processing step, status information containing the specified printing error type is generated regardless of an actual printing error type.

The above embodiment makes it possible to specify a printing error type to be included in status information, thereby supporting a wide range of mission-critical systems each of which systems having information processing apparatuses that can respond to a different printing error type.

According to an embodiment of the present invention, when two or more information processing apparatuses are connected to the communication network, a printing error type to be included in status information can be specified for each of the information processing apparatuses.

According to the above embodiment, a printing error type to be included in status information can be specified for each of multiple information processing apparatuses. This mechanism eliminates the need to make changes to an information processing apparatus and thereby makes it possible to efficiently implement a printing system even in a mission-critical system having multiple information processing apparatuses.

The present invention is not limited to the specifically disclosed embodiments, and variations and modifications may be made without departing from the scope of the present invention.

The present application is based on Japanese Priority Application No. 2005-274420, filed on Sep. 21, 2005, the entire contents of which are hereby incorporated herein by reference.

What is claimed is:

1. An image forming apparatus, comprising:
an interface unit configured to send/receive data via a communication network to/from an information processing apparatus;
a storage unit configured to store a set of print data sent via the communication network from the information processing apparatus; and
a data processing unit configured to start a print job for printing the set of print data and to cancel the started print job when the printing of the set of print data is suspended because of a printing error.

2. The image forming apparatus as claimed in claim 1, wherein the data processing unit, after canceling the started print job, generates status information containing a printing error type of the printing error and a number of pages that have been successfully printed before the cancellation of the started print job; and causes the interface unit to send the generated status information to the information processing apparatus.

3. The image forming apparatus as claimed in claim 1, wherein the data processing unit, when canceling the started print job, also cancels all the sets of print data stored in the storage unit.

4. The image forming apparatus as claimed in claim 1, wherein the image forming apparatus is connected via the communication network to two or more of the information processing apparatuses, the image forming apparatus further comprising:
a registration user interface unit configured to input a job cancellation setting for each of the information processing apparatuses, wherein the data processing unit determines according to the input job cancellation setting whether to cancel a print job; and
an information processing apparatus registration unit configured to register the input job cancellation setting.

5. The image forming apparatus as claimed in claim 4, wherein multiple job cancellation settings each corresponding to a printing error type are input and registered for each of the information processing apparatuses.

6. The image forming apparatus as claimed in claim 5, wherein each of the sets of print data contains a control command that specifies job cancellation settings each corresponding to a printing error type.

7. The image forming apparatus as claimed in claim 6, wherein the data processing unit gives priority to the job cancellation settings specified by the control command over the job cancellation settings registered in the information processing apparatus registration unit.

8. The image forming apparatus as claimed in claim 2, wherein the data processing unit generates status information containing a fixed printing error type regardless of an actual printing error type.

9. The image forming apparatus as claimed in claim 2, wherein a printing error type to be included in status information can be specified; and the data processing unit generates status information containing the specified printing error type regardless of an actual printing error type.

10. The image forming apparatus as claimed in claim 9, wherein the image forming apparatus is connected via the communication network to two or more of the information processing apparatuses; and a printing error type to be included in status information can be specified for each of the information processing apparatuses.

11. An information processing apparatus, comprising:
a print data generating unit configured to generate print data;
an interface unit configured to send the print data via a communication network to an image forming apparatus and to receive status information via the communication network from the image forming apparatus; and
a data processing unit configured to generate, when the status information contains information indicating that a print job corresponding to the print data has been canceled, another set of print data based on a number of pages that have been successfully printed before the cancellation of the print job which number of pages is contained in the status information, and to cause the interface unit to send said another set of print data to another image forming apparatus to continue the print job on said another image forming apparatus.

12. A printing system, comprising:
two or more of the image forming apparatuses as claimed in claim 1; and
one or more information processing apparatuses each of the information processing apparatuses including a print data generating unit configured to generate print data; an interface unit configured to send the print data via a communication network to one of the image forming apparatuses and to receive status information via the communication network from the one of the image forming apparatuses; and a data processing unit configured to generate, when the status information contains information indicating that a print job corresponding to the print data has been canceled, another set of print data based on a number of pages that have been successfully printed before the cancellation of the print job which number of pages is contained in the status information, and to cause the interface unit to send said another set of print data to another one of the image forming apparatuses to continue the print job on said another one of the image forming apparatuses.

13. An image forming method, comprising:
a receiving step of receiving a set of print data sent via a communication network from an information processing apparatus;
a storing step of storing the set of print data; and
a data processing step of starting a print job for printing the set of print data and canceling the started print job when the printing of the set of print data is suspended because of a printing error.

14. The image forming method as claimed in claim 13, wherein, in the data processing step, after the started print job is canceled, status information is generated which status information contains a printing error type of the printing error and a number of pages that have been successfully printed before the cancellations of the started print job; and the generated status information is sent to the information processing apparatus.

15. The image forming method as claimed in claim 13, wherein, in the data processing step, when the started print job is canceled, all the sets of print data stored in the storage step are also canceled.

16. The image forming method as claimed in claim 13, further comprising:
a job cancellation setting input step of inputting multiple job cancellation settings for each said information processing apparatus each of which job cancellation settings corresponding to a printing error type; and
a job cancellation setting registration step of registering the input job cancellation settings, wherein
each set of print data contains a control command that specifies job cancellation settings each corresponding to a printing error type;
whether to cancel a print job is determined in the data processing step according to the job cancellation settings; and
the job cancellation settings specified by the control command are given priority over the job cancellation settings registered in the job cancellation setting registration step.

17. The image forming method as claimed in claim 14, wherein, in the data processing step, status information containing a fixed printing error type is generated regardless of an actual printing error type.

18. The image forming method as claimed in claim 14, wherein a printing error type to be included in status information can be specified; and in the data processing step, status information containing the specified printing error type is generated regardless of an actual printing error type.

19. The image forming method as claimed in claim 18, wherein two or more of the information processing apparatuses are connected to the communication network; and a printing error type to be included in status information can be specified for each of the information processing apparatuses.
